(19) United States
(12) Patent Application Publication
(10) Pub. No.: US 2007/0154283 A1
(43) Pub. Date: Jul. 5, 2007

(54) Magnetic bolt covers

(75) Inventors: Jason A. Thurow, Wilton, WI (US); Timothy T. Tiller, Blue River, WI (US)

Correspondence Address: STEPTOE & JOHNSON LLP, 1330 CONNECTICUT AVENUE, N.W., WASHINGTON, DC, 20036, US

(73) Assignee: S & S Cycle, Inc., Viola, WI (US)

(21) Appl. No.: 11/705,085

(22) Filed: Feb. 12, 2007

Related U.S. Application Data
(62) Division of application No. 11/082,755, filed on Mar. 18, 2005, now abandoned.

(51) Int. Cl. F16B 37/14

(52) U.S. Cl. 411/372.6

(57) ABSTRACT

A cover is provided with a body including an internal periphery shaped to receive one of a fastener, a plug and a knob in the body; and a magnet positioned within the body. The magnet removably couples the body to the received fastener, plug or knob when positioned in the body. Preferably, an internal periphery of the body closely conforms to an outer periphery of the fastener, plug or knob to be received therein.

### BACKGROUND OF THE INVENTION

1. Field of the Invention

The present invention is generally directed at removable covers, and more particularly to removable fastener covers including a body and a magnet positioned within the body.

2. Description of the Related Art

Bolts, nuts, screws, and other fasteners are used in a variety of applications, including automobiles, all terrain vehicles (ATVs), snowmobiles, motorcycles, boats, planes, trains, etc. Exposed fasteners are not aesthetically appealing and are subjected to environmental conditions which may cause them to corrode over time. Thus, a need exists for protecting exposed fasteners from environmental conditions in an aesthetically pleasing manner.

Known fastener covers are often attached to fasteners using a set screw. However, set screws require set screw holes, which add machining operations that increase fastener cover fabrication costs. In addition, set screws and set screw holes are not aesthetically appealing, and may damage fasteners when installed (e.g., a tip of a set screw may scratch a surface of the fastener when installed). Finally, the presence of set screws requires tools to install or remove the set screws, which complicates installation and removal of the fastener cover. Thus, the use of set screws is undesirable for many applications.

Other known fastener covers are often attached to fasteners using an adhesive. Adhesives require long set times during installation to allow the adhesive to adequately cure. In addition, adhered fastener covers makes removal difficult due to the semi-permanent nature of attachment. Specifically, adhered fastener covers must be pried off of the fasteners they are installed on, and any residual adhesive must be removed prior to re-installation if re-installation is even possible. Thus, the use of adhesively attached fastener covers is also undesirable for many applications.

Other problems with the prior art not described above can also be overcome using the teachings of the present invention, as would be readily apparent to one of ordinary skill in the art after reading this disclosure.

### BRIEF DESCRIPTION OF THE DRAWINGS

FIG. 1 shows a bottom view of a fastener cover according to an embodiment of the present invention.

FIG. 2 shows a top view of the fastener cover of FIG. 1.

FIG. 3 shows a side view of the fastener cover of FIG. 1.

FIG. 4 shows a sectional view of the fastener cover of FIG. 1, cut along plane 4-4.

FIG. 5 shows a peripheral view of the fastener cover of FIG. 1.

FIG. 6 shows a sectional view of a fastener received within a fastener cover according to an embodiment of the present invention.

FIG. 7 shows a sectional view of a fastener received within a fastener cover according to another embodiment of the present invention.

FIG. 8 shows a sectional view of a fastener received within a fastener cover according to another embodiment of the present invention.

### DETAILED DESCRIPTION OF EXEMPLARY EMBODIMENTS

Reference will now be made in detail to exemplary embodiments of the present invention. Wherever possible, the same reference numbers will be used throughout the drawings to refer to the same or like parts.

The present invention is directed at covers for covering an exposed surface of a device such as fasteners, knobs, plugs, etc. For purposes of illustration and simplicity, only embodiments directed at fastener covers will be described in this section. Fastener covers are covers that obscure from view at least a portion of a fastener—a “fastener” being any device that mechanically attaches structures to one another, such as bolts, nuts, screws, staples, rivets, nails, etc. While fastener covers are discussed in the embodiments below, it should be appreciated to those of skill in the art that various teachings of the present invention may be applied to other areas such as plug covers, knob covers and boss covers.

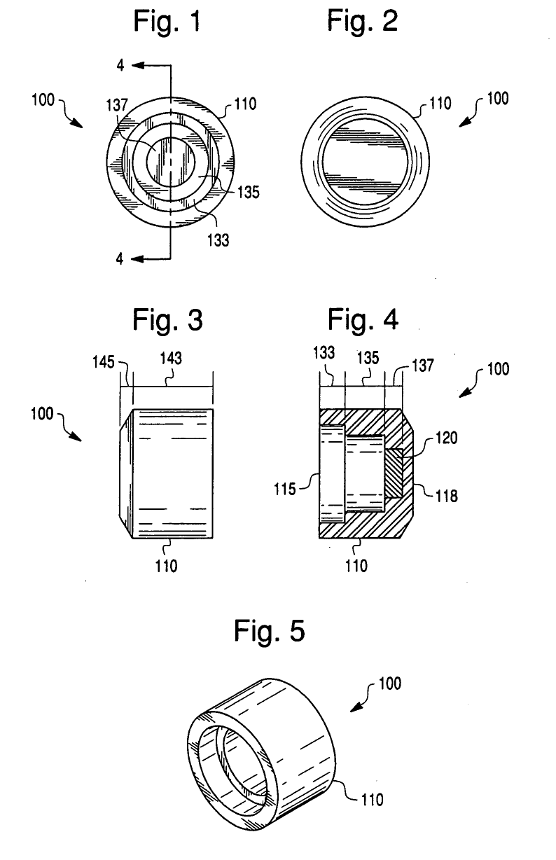

A fastener cover 100 according to a first embodiment of the present invention is shown in FIGS. 1-5 and FIG. 8. In particular, the fastener cover 100 shown has a body 110 including an internal periphery shaped to receive a fastener 1000 in the body 110. As an example, the internal periphery may be shaped so as to be slightly larger than an outer periphery of a fastener 1000 to be received in the body 110. Alternatively, the internal periphery may be shaped so as to substantially conform to the outer periphery of the fastener 1000 to be received in the body 110. The internal periphery may be substantially cylindrical as shown, may include one or more substantially flat regions or slats (e.g., a hex pattern to correspond to a hex nut/bolt), or may have any other shape depending on the particular application at hand. Preferably, the internal periphery has a shape that allows for easy insertion of a fastener 1000 into the body 110 and securely retains a received fastener 1000 in the body 110, yet allows for a received fastener 1000 to be removed from the body 110 for repair or replacement purposes. Hence, shape and size variations are contemplated to accommodate different applications and differently shaped fasteners.

According to one embodiment of the present invention, the internal periphery includes at least three regions 133, 135, 137. The first region 133 may extend from an opening 115 in the body 110 toward a closed end 118 in the body 110, the first region 133 having a first diameter. The second region 135 may extend from the first region 133 toward the closed end 118 in the body 110, the second region 135 having a second diameter smaller than the first diameter. The third region 137 may extend from the second region 135 toward the closed end 118 in the body 110, the third region 137 having a third diameter smaller than the second diameter. The three regions 133, 135, 137 may have a substantially uniform depth, or may have different depths as best shown in the cross sectional view of FIG. 4. The fastener cover 100 may include at least one magnet 120 positioned within the third region 137 of the body 110. As shown in FIG. 8, the magnet 120 couples the body 110 to the fastener 1000 when the fastener 1000 is received in the body 110.

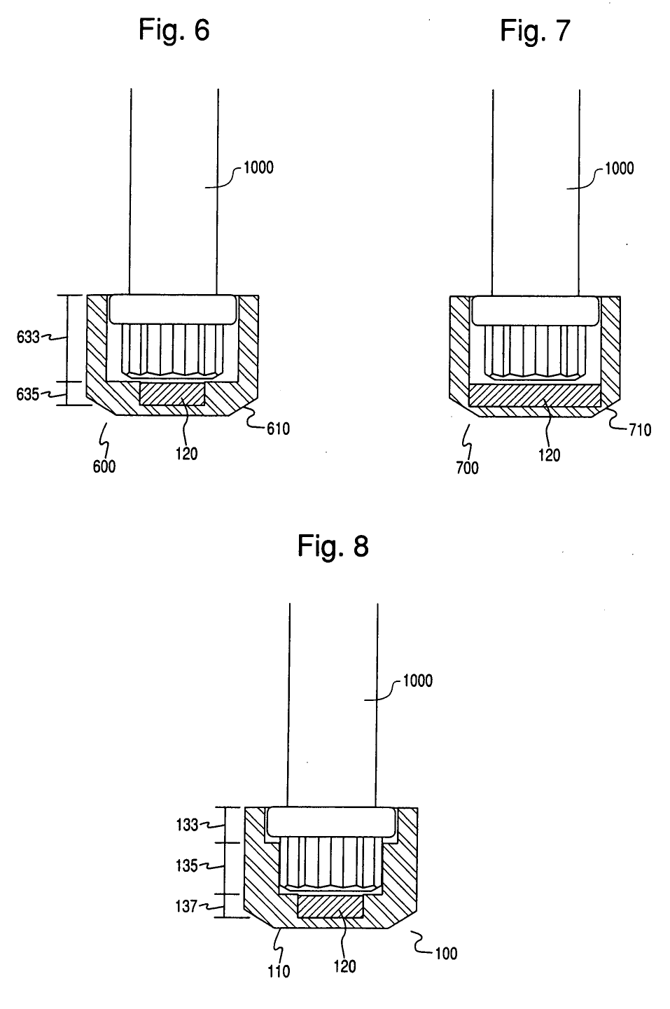

According to another embodiment of the present invention as shown in FIG. 6, the internal periphery may include at least two regions 633, 635. The first region 633 may extend from an opening 115 in the body 610 toward a closed end 118 in the body 610, the first region 633 having a first diameter. The second region 635 may extend from the first region 633 toward the closed end 118 in the body 610, the second region 635 having a second diameter smaller than the first diameter. The two regions 633, 635, may have a substantially uniform depth, or may have different depths. The fastener cover 600 may include at least one magnet 120 positioned within the second region 635 of the body 610. As shown in FIG. 6, the magnet 120 couples the body 610 to the fastener 1000 when the fastener 1000 is received in the body 610.

According to yet another embodiment of the present invention as shown best in FIG. 7, the internal periphery may include only one region with a substantially uniform diameter. The fastener cover 700 may include at least one magnet 120 positioned within this region in body 710, opposite opening 115 in the body 710. As shown in FIG. 7, the magnet 120 couples the body 710 to the fastener 1000 when the fastener 1000 is received in the body 710.

While three different configurations are shown in FIG. 6-Fig. 8, it should be appreciated that the present invention contemplates additional configurations such as bodies having four, five, six or more regions. Thus, it should be appreciated that the configurations shown in FIG. 6-FIG. 8 are for illustration purposes only.

With any one of the aforementioned configurations, the magnet 120 may be attached to the body 110 using any number of techniques, including coupling the magnet 120 to the body 110 with a set screw (or other coupler), adhering the magnet 120 to the body 110 with an adhesive or other bonding material (e.g., glue), or press fitting the magnet 120 within a region in the body 110. As an example, the magnet 120 in FIG. 4 is shown press fitted into the third region 137 of the internal periphery such that it does not substantially project into the second region 135 of the internal periphery. Other attaching techniques are also contemplated, such as the magnetic force of the magnet 120 itself holding it within and attaching it to the body 110.

It should be appreciated that the magnet 120 may be positioned such that it does not substantially project into the second region 135 (e.g., flush with or recessed in reference to a bottom surface of second region 135) as shown, for example, in FIG. 6 and FIG. 8. Such a configuration is preferable in applications with relatively high amounts of vibration, including fastener covers used in engine assemblies. This is due to the potential breakage of magnet 120 when directly contacting fastener 1000, if the assembly is subjected to relatively high amounts of vibration. However, in applications with relatively low amounts of vibration, the magnet 120 may be positioned such that it does project into the second region 135. In such applications, the magnet 120 preferably contacts the fastener 1000 when the fastener 1000 is received in body 110. This increases the retention force applied to fastener 1000, due to the direct contact between magnet 120 and fastener 1000. Breakage is less of a concern in such applications, where the assembly is subjected to minimal (or no) vibrations. Thus, the configurations shown in FIG. 1-8 are for illustration purposes only.

With any attaching technique, the magnet 120 is preferably attached to the body 110 in such a manner as to withstand a pull force of at least about 30 lb. Alternatively, all or a substantial portion of the body 110 may be magnetized such that the “magnet” 120 is dispersed throughout the body 110- i.e., the body 110 itself acts as the magnet 120. This eliminates the need to attach the magnet 120 to the body 10 in a manner that can withstand the noted pull force.

In addition, the magnet 120 preferably has magnetic strength of sufficient capacity such that an installed fastener cover 100 (i.e., with a fastener 1000 received therein) can withstand a pull force of at least about 4 lb. This helps prevent the fastener cover 100 from inadvertently coming off of a received fastener 1000 after installation. As different applications will have different retention requirements (e.g., due to heat, vibration, or other environmental conditions), other configurations are also contemplated.

According to one embodiment of the present invention, the body 110 also includes a rounded, beveled or chamfered portion on an outer periphery as shown best in FIG. 3. In particular, an outer periphery of the body may include a first region 143 extending from an opening 115 in the body toward a closed end 118 in the body 110, and a second region 145 extending from the first region 143 toward the closed end 118 in the body 110. The second region 145 may include a rounded/beveled/chamfered portion to remove burrs and/or sharp edges formed during a machining process. As an example, the second region 145 may taper from the first region 143 to the closed end 118 of the body 110. It should be appreciated that rounding on the edges may occur as a result of polishing operations and the like.

Further, a protective coating may be applied to all or part of the body 110. As an example, at least a portion of an outer periphery of the body 110 may be chrome plated, painted, polished or powder coated. Protective coatings service multiple purposes, including protecting the body 110 from environmental conditions and providing a more aesthetically appealing appearance. As such, a protective coating is preferably applied to substantially an entire outer periphery of the body 110. The internal periphery may also be covered in whole or in part with such a protective coating. Other variations are also contemplated.

It is also contemplated to provide a gripping surface on all or a part of the body 110. As an example, the body 110 may include one or more grooves and/or knurling as a gripping surface. Gripping surfaces may improve removability of the fastener cover 100, particularly when covered in a slippery substance such as oil.

According to another embodiment of the present invention, components of the disclosed fastener cover 100 may be formed out of one or a combination of many different materials. As an example, the body 110 may be formed from one of steel (e.g., stainless steel or carbon steel), aluminum, brass, elastomers, silicone, stone, and plastic. For engine applications that involve relatively high temperatures, the body 110 is preferably formed of a material capable of withstanding temperatures of at least about 450° F. Other materials are also contemplated.

According to another embodiment of the present invention, the magnet 120 may be formed from a rare earth material, such as samarium cobalt. However, it should be appreciated that magnetic properties of materials vary with temperature. As such, the material for magnet 120 should be selected for the particular implementation at hand. For engine applications that involve relatively high temperatures, the magnet 120 is preferably formed of a material capable of withstanding temperatures of at least about 450° F. and having sufficient magnetic properties at such a temperature. Other materials are also contemplated.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. As an example, it is contemplated to provide insignias or other customization features on one or more surfaces of the body 110 (e.g., a company logo on the outer surface of the closed end of the body). Thus, the embodiments were chosen and described in order to explain the principles of the invention and its practical application to enable one skilled in the art to utilize the invention in various embodiments and with various modifications as are suited to the particular use contemplated.

PARTS LIST

| | |
|---|---|
| body | 110, 610, 710 |
| closed end in the body | 118 |
| fastener | 1000 |
| fastener cover | 100, 600, 700 |
| first region of internal periphery | 133, 633 |
| first region of outer periphery | 143 |
| magnet | 120 |
| opening in the body | 115 |
| second region of internal periphery | 135, 635 |
| second region of outer periphery | 145 |
| third region of internal periphery | 137 |

1. (canceled)

2. (canceled)

3. (canceled)

4. (canceled)

5. A cover comprising:
a body including an internal periphery shaped to receive one of a fastener, a plug and a knob in the body, the internal periphery including
a first region extending from an opening in the body toward a closed end in the body, the first region having a first diameter; and
a second region extending from the first region toward the closed end in the body, the second region having a second diameter; and
a magnet positioned within the body, the magnet coupling the body to the received fastener, plug or knob when positioned in the body,
wherein the first diameter is larger than the second diameter, and
wherein the magnet is positioned within the second region.

6. The cover of claim 5, wherein the magnet does not substantially project into the first region when positioned in the second region.

7. The cover of claim 5, wherein the magnet projects into the first region when positioned in the second region.

8. (canceled)

9. (canceled)

10. (canceled)

11. (canceled)

12. A cover comprising:
a body including an internal periphery shaped to receive one of a fastener, a plug and a knob in the body; and
a magnet positioned within the body, the magnet coupling the body to the received fastener, plug or knob when positioned in the body,
wherein the body is magnetized such that the magnet is dispersed throughout the body.

13. A cover comprising:
a body including an internal periphery shaped to receive one of a fastener, a plug and a knob in the body; and
a magnet positioned within the body, the magnet coupling the body to the received fastener, plug or knob when positioned in the body,
wherein the body has an outer periphery comprising:
a first region extending from an opening in the body toward a closed end in the body; and
a second region extending from the first region toward the closed end in the body,
wherein the second region tapers from the first region to the closed end in the body.

14. The cover of claim 5, wherein the body is formed from one of steel, aluminum, brass, elastomers, silicone, stone, and plastic.

15. The cover of claim 5, further comprising one of a powder coating, a paint, a polish and a chrome plating substantially covering an outer periphery of the body.

16. The cover of claim 5, wherein the magnet is attached to the body in such a manner as to withstand a pull force of at least about 30 lb.

17. The cover of claim 5, wherein the magnet couples the body to the received fastener, plug or knob in such a manner as to withstand a pull for of at least about 4 lb.

18. The cover of claim 5, wherein the magnet is formed of a rare earth material capable of withstanding temperatures of at least 450° F.

19. The cover of claim 5, wherein the magnet is attached to the body by one of an adhesive, a coupler, a press fit application, and magnetic forces.

20. (canceled)

21. (canceled)

22. (canceled)

23. (canceled)

24. (canceled)

25. (canceled)

26. A method of manufacturing a fastener cover, comprising:
shaping an internal periphery of a body to receive a fastener in the body; and
attaching a magnet to the body, the magnet coupling the body to the fastener when the fastener is received in the body.

27. The method of claim 26, wherein attaching the magnet to the body comprises at least one of:
coupling the magnet to the body with a set screw;
adhering the magnet to the body with a bonding material; press fitting the magnet within a region in the body; and
magnetically holding the magnet in the body.

28. The method of claim 26, further comprising at least one of:
chrome plating an outer periphery of the body;
painting the outer periphery of the body;
polishing the outer periphery of the body; and
powder coating the outer periphery of the body.

29. The cover of claim 13, wherein the body is formed from one of steel, aluminum, brass, elastomers, silicone, stone, and plastic.

30. The cover of claim 13, further comprising one of a powder coating, a paint, a polish and a chrome plating substantially covering the outer periphery of the body.

31. The cover of claim 13, wherein the magnet is attached to the body in such a manner as to withstand a pull force of at least about 30 lb.

32. The cover of claim 13, wherein the magnet couples the body to the received fastener, plug or knob in such a manner as to withstand a pull for of at least about 4 lb.

33. The cover of claim 13, wherein the magnet is formed of a rare earth material capable of withstanding temperatures of at least 450° F.

34. The cover of claim 13, wherein the magnet is attached to the body by one of an adhesive, a coupler, a press fit application, and magnetic forces.
